(19) United States
(12) Patent Application Publication
(10) Pub. No.: US 2011/0204010 A1
(43) Pub. Date: Aug. 25, 2011

(54) FLEXIBLE WINE RACK SYSTEMS

(76) Inventors: Ruble Hastu, New York, NY (US); Joseph Kelly, New York, NY (US)

(21) Appl. No.: 13/004,026

(22) Filed: Jan. 11, 2011

Related U.S. Application Data
(60) Provisional application No. 61/306,998, filed on Feb. 23, 2010.

(51) Int. Cl. A47B 73/00; B23P 11/00

(52) U.S. Cl. 211/74; 29/428

(57) ABSTRACT

A modular, vertically self-standing wine rack comprising a first vertical planar member and a second vertical planar member having equal measurements and each comprising a plurality of bottle-sized cylindrical through-hole apertures for receiving and retaining bottles of wine. The first vertical planar member and second vertical planar member may be securely held in place at by at least two hinges in a 90 degree adjacent relation to each other thereby the wine rack of the present invention to be self-standing. The through-holes of the present invention may comprise a diameter of 3 inches providing a suitably-sized contact-retention inner circumference surface area for a wine bottle containing a fluid volume of about 750 ml.

### CROSS-REFERENCE TO RELATED APPLICATION

The present application is related to and claims priority from prior provisional application Ser. No. 61/306,998, filed Feb. 23, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of wine racks and more specifically relates to a modular, self-supporting wine rack which may be flexibly arranged by itself and with other like wine racks.

2. Description of the Related Art

Wine is an immensely popular alcoholic beverage enjoyed by a large population of adult drinkers. Many social drinkers prefer the non-carbonated and robust flavors of wine as opposed to beer and tonic beverages. Others enjoy wine as a vital compliment to a meal. A Finnish study of 2,468 men over a 29-year period, published in the Journals of Gerontology, 2007 concluded that wine drinkers have a 34 percent lower mortality rate than beer or spirits drinkers. This is attracts many elderly drinkers and other health conscientious social drinkers to selecting wine over other options.

Most wine enthusiasts store wine in their home so that it is always on hand when needed. Storing multiple bottles of wine can take up valuable space and detract from the decor of a room. Thus, a significant amount of individuals, ranging from the avid wine connoisseurs to the every now-and-then wine drinker utilize wine racks to store and display their wine. A wine rack is a device that stores and organizes wine. Wine racks may be built out of a number of different materials. The size of the rack and the number of bottles it may hold can vary widely. Wine racks may be located in a winemaker's professional wine cellars as well as private homes for personal collections. Ideally, a wine rack should add ambience to a room atmosphere while providing an attractive and space-efficient display of a plurality of wine bottles. However, one problem that often arises for home owners looking for a stylish wine rack is that it may be difficult to find a rack that is both functional and aesthetically pleasing. Some individuals are hesitant to display the rack in their home for fear that it will be an eyesore. A more efficient option is needed.

Various attempts have been made to solve the above-mentioned problems such as those found in U.S. Pat. and Pub. Nos. 5,025,936, D222,950, 4,482,065, 2007/0108143, and D414,991. This prior art is representative of wine racks. None of the above inventions and patents, taken either singly or in combination, is seen to describe the invention as claimed.

Ideally, a modular, self-supporting wine rack should be aesthetically pleasing and user-friendly and, yet, would operate reliably and be manufactured at a modest expense. Thus, a need exists for a reliable modular wine rack system to stand in a vertical position in a self-supporting manner and to retain a plurality of wine bottles in a flexible and aesthetically pleasing display and to avoid the above-mentioned problems.

### BRIEF SUMMARY OF THE INVENTION

In view of the foregoing disadvantages inherent in the known wine display rack art, the present invention provides a novel modular, self-standing wine rack system. The general purpose of the present invention, which will be described subsequently in greater detail, is to provide a self-standing, aesthetically pleasing modular wine rack which may serve to retain a plurality of wine bottles.

The present invention holds significant improvements and serves as a flexible wine rack system. A modular-flexible self-supporting wine rack is described herein comprising a first vertically-orientated planar member, a second vertically-orientated planar member, wherein both the first and second vertically-orientated planar member are attached in a perpendicular 90 degree relation to each other by at least two hinges. Both the first and second vertically-orientated planar member may comprise a plurality of cylindrical, bottle-sized apertures comprising through-holes. Wine bottles may be insertably stored within the through-hole(s). Preferably, the first vertically-orientated planar member and the second vertically-orientated planar member comprise an arrangement of three rows and two columns of through-holes and are assembled such that the rows of through-holes are staggered permitting maximum storage space for the wine bottles.

Preferably, the vertically-orientated planar members of the present invention comprise oak having a smoothed-polished appearance. Furthermore, the first and second vertically-orientated planar members may comprise corners which are rounded and a smooth-finished exterior surface. The hinges preferably comprise brass and may be used to secure the first vertically-orientated planar member to the second vertically-oriented planar member thereby creating a self-supporting modular wine rack for the retention of a plurality of wine bottles. As such, the present invention provides a very aesthetically-pleasing and functional furniture item for conveniently storing and displaying wine.

In a preferred embodiment of the present invention, the plurality of through-holes may comprise a width of about 3 inches. In such a manner, the through-holes comprise a circumference just large enough to retain a wine bottle comprising a liquid volume of approximately 750 ml. The wine bottles may be insertably placable into touch-contact with the circumference surface area of the through-holes and may be securely held in place via frictional counter-balancing of the 750 ml wine bottle within the through-hole in the vertically-orientated planar member.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, flexible wine rack systems, constructed and operative according to the teachings of the present invention.

FIG. 1 shows a perspective view illustrating flexible wine rack systems in an in-use condition retaining a plurality of wine bottles.

FIG. 2 is a perspective view illustrating a flexible wine rack comprising a first planar member, second planar member, and at least two hinges in an assembled condition according to an embodiment of the present invention of FIG. 1.

FIG. 3 is a perspective view illustrating two flexible wine rack systems in an accordian alignment according to an embodiment of the present invention of FIG. 1.

FIG. 4 is a perspective view illustrating two flexible wine rack systems in a square alignment according to an alternative arrangement of the present invention FIG. 1.

FIG. 5 is a perspective view illustrating two flexible wine rack systems in a criss-cross alignment according to an alternative arrangement of the present invention FIG. 1.

FIG. 6 is a flowchart illustrating a method of use of a flexible wine rack system according to an embodiment of the present invention FIG. 1.

The various embodiments of the present invention will hereinafter be described in conjunction with the appended drawings, wherein like designations denote like elements.

### DETAILED DESCRIPTION

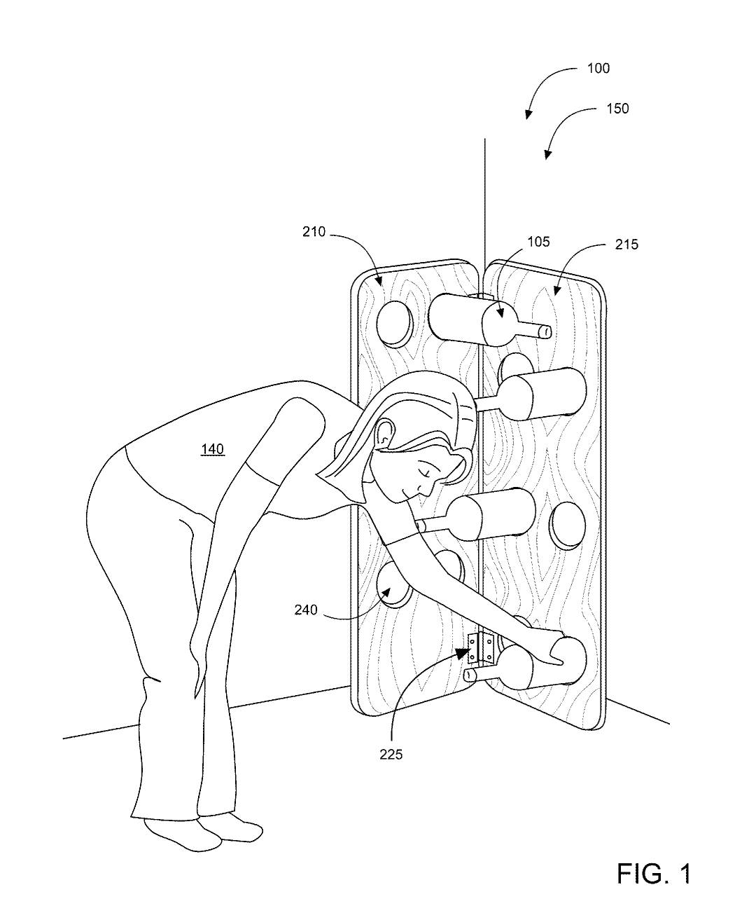

As discussed above, embodiments of the present invention relate to a flexible wine rack system and more particularly to a self-standing, aesthetically pleasing, modular wine rack which retains a plurality of wine bottles. Referring to the drawings by numerals of reference there is shown in FIG. 1, flexible wine rack systems 100 in an in-use condition 150 retaining wine bottle(s) 105 to be openly displayed in the corner of a room and to store wine bottle(s) 105 for future use. As seen, user 140 may insert wine bottle 105 into through-hole 240 of either first planar member 210 or second planar member 215. As will be discussed subsequently in greater detail, wine bottle 105 may be frictionally retained securely within through-hole 240 by user 140 such that wine bottle 105 will not accidentally fall to the ground, floor or other supporting planar surface. As seen in FIG. 1, flexible wine rack systems 100 may be conveniently stored in the corner of a room thereby optimizing space usage and efficiency.

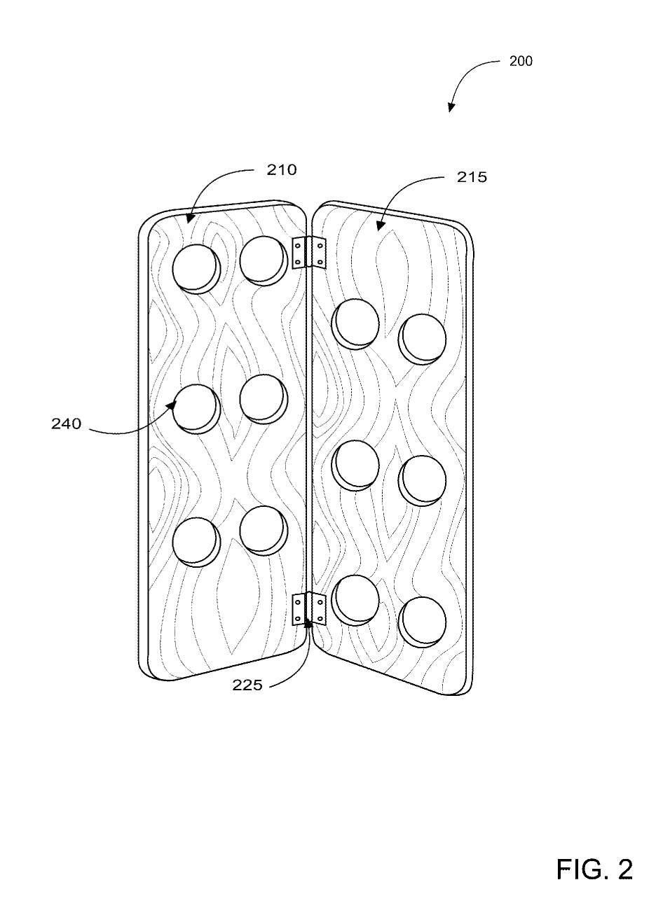

Referring now to FIG. 2, flexible wine rack systems 100 may comprise flexible wine rack assembly 200 comprising first vertically-orientated planar member 210, second vertically-orientated planar member 215, and at least two hinges 225. First planar member 210 and second planar member 215 each may comprise a plurality of through-holes 240 wherein through-hole 240 comprises a cylindrical bottle-sized aperture for insertably receiving wine bottle 105. In an embodiment of the present invention as shown in FIG. 2, through-holes 240 may be arranged into three rows and two columns in each of first vertically-orientated planar member 210 and second vertically-orientated planar member 215 thereby comprising a total of six through-holes 240 per planar member. In other embodiments there may be more or less of through-holes 240, according to relative size of wine bottles 105.

In a preferred assembled condition of flexible wine rack assembly 200, first vertically-orientated planar member 210 and second vertically-orientated planar member 215 are securably attached at a perpendicular orientation to one another by at least two hinges 225. Hinges 225 may preferably be located along an upper portion and lower portion of first vertically-orientated planar member 210 and second vertically-orientated planar member 215 respectively serving to hold first vertically-orientated planar member 210 and second vertically-orientated planar member 215 in a 90 degree adjacent relation to each other. In such a manner, flexible wine rack assembly 200 may be vertically self-standing. Furthermore, first vertically-orientated planar member 210 and second vertically-orientated planar member 215 are preferably assembled such that the three rows and the two columns of through-holes 240 are staggered in relation to each other thereby permitting vertically-staggered wine-storing space for wine bottles 105. As will be appreciated by space conservers, the vertically-staggered through-holes 240 permit the optimal and efficient use of space of flexible wine rack systems 100.

In one embodiment of the present invention as seen in FIGS. 1 and 2, through-holes 240 may comprise a diameter of 3 inches thereby providing a suitably-sized contact-retention inner circumference surface area for wine bottle 105 wherein wine bottle 105 contains a fluid volume of about 750 ml. The preferred 3 inch diameter of through-hole 240 allows for wine bottle 105 containing a fluid volume of about 750 ml to be insertably placed by user 140 into touch-contact with the circumference surface area of through-hole 240 thereby enabling wine bottle 105 to be securely held and retained in place via frictional counter-balancing of wine bottle 105 within through-hole 240. In alternative embodiments of the present invention, through-holes 240 may comprise various circumferences allowing retention of different size wine bottles 105 having a liquid volume less than or greater than 750 ml.

To achieve a polished look and attractive design, first vertically-orientated planar member 210 and second vertically-orientated planar member 215 may be manufactured using wood comprising oak providing an appearance of a smooth-finished and stained exterior surface of flexible wine rack systems 100. It should further be appreciated that hinges 225 may comprise brass. The lusterly appearance of the brass serves to provide an aesthetically pleasing contrast to the polished-stained appearance of the oak wood of first vertically-orientated planar member 210 and second vertically-orientated planar member 215. Furthermore, first vertically-orientated planar member 210 and second vertically-orientated planar member 215 may comprise rounded corners further enhancing the sleek and stylish appearance of flexible wine rack systems 100. According to a preferred embodiment of the present invention as seen in FIGS. 1 and 2, first vertically-orientated planar member 210 and said second vertically-orientated planar member 215 comprise an identical width of about 11½ inches and a height of about 48 inches providing sufficient and efficient storage means for at least twelve wine bottles 105 per flexible wine rack assembly 200.

Although not shown in the accompanying illustrations, flexible wine rack assembly 200 may additionally comprise floor protectors that may serve to protect a floor from damage. Floor protectors may be removably attached along a bottom edge of first vertically-orientated planar member 210 and second vertically-orientated planar member 215. In use, floor protectors may protect hard wood floors, tiled floors, carpeted floors, and rugs from scuffing, scratching, and other types of damage caused by moving or re-positioning flexible wine rack assembly(s) 200.

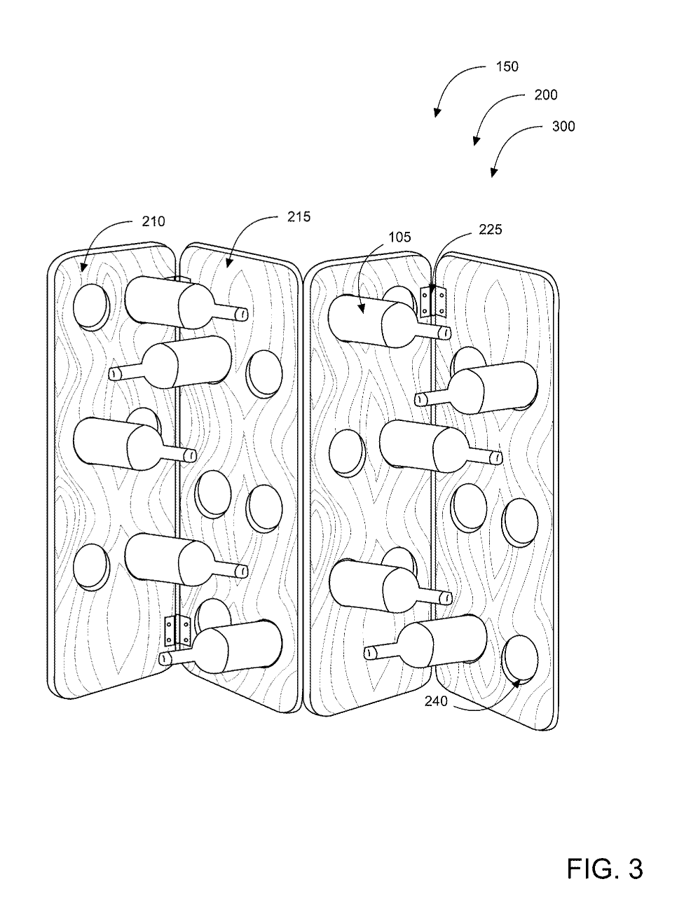

Referring now to FIG. 3, illustrating flexible wine rack systems 100 in an in-use condition 150 according to one arrangement of two flexible wine rack assemblies 200. As shown in FIG. 3, two flexible wine rack assemblies 200 may be arranged in an accordion alignment 300 by positioning at least two flexible wine rack assemblies 200 side-by-side adjacent to each other. Such a balance-displayable accordion alignment 300 enables the storage of additional wine bottles 105 in an attractive and space efficient display against a wall or in the interior of a room.

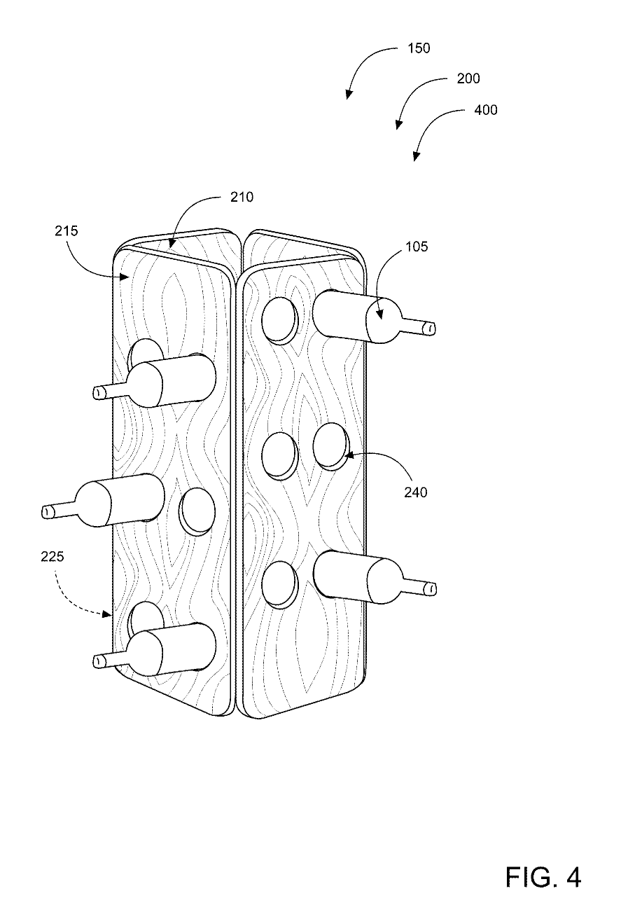

Referring now to FIG. 4, illustrating flexible wine rack systems 100 in an in-use condition 150 according to an alternative arrangement of the present invention. As shown in FIG. 3, two flexible wine rack assemblies 200 may be arranged in a square alignment 400 by adjoining the outer sides of first vertically-orientated planar member 210 and second vertically-orientated planar member 215 of two flexible wine rack assemblies 200 thereby forming a square. Such a balance-displayable arrangement allows for the storage of additional wine bottles 105 in an attractive and space-efficient display.

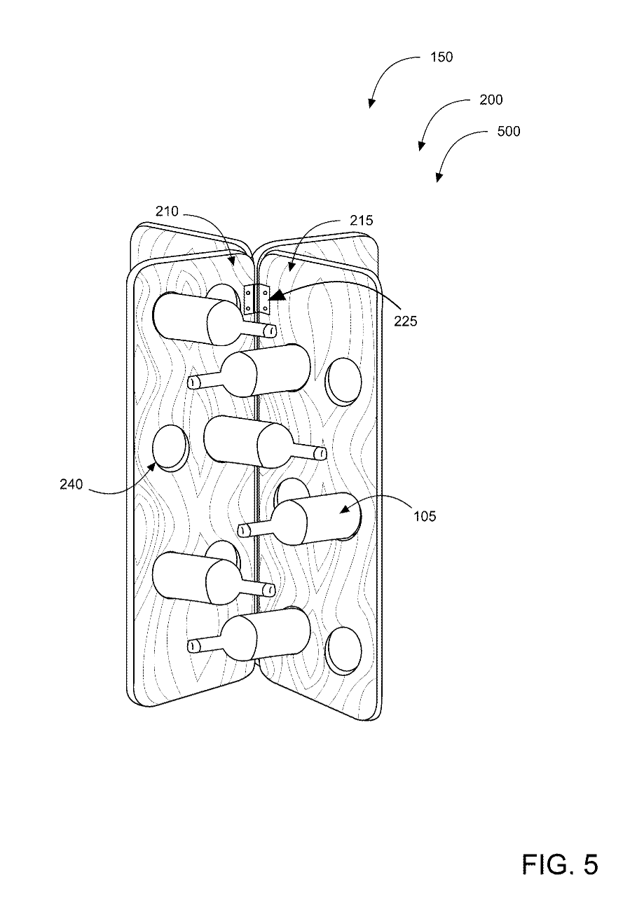

Referring now to FIG. 5, illustrating flexible wine rack systems 100 in an in-use condition 150 according to an alternative arrangement comprising two flexible wine rack assemblies 200. As shown in FIG. 5, two flexible wine rack assemblies 200 may be arranged in a criss-cross alignment 500 by positioning the hinged corners of first vertically-orientated planar member 210 and second vertically-orientated planar member 215 of both assemblies adjacent to one another such that four vertical planar members extend outward from the center at 90 degree angles. Such a balance-displayable arrangement permits the storage of additional wine bottles 105 in an attractive and space- efficient display.

It should be appreciated that the flexible characteristic of the present invention may be best realized when utilizing at least two or more flexible wine rack assemblies 200 which may be presented in a wide array of alternative arrangements in addition to accordion alignment 300, square alignment 400, and criss-cross alignment 500 which may not be disclosed herein to achieve various displays for storing wine bottles 105. For example, user 140, an avid wine connoisseur, may wish to select accordion alignment 300 to display wine bottle(s) 105 comprising a vintage collection from an especially good year. Accordion alignment 300 may be movably positionable along a wall perimeter and may serve to provide the greatest amount of surface area facing an outward direction. Thus, wine bottle(s) 105 may be displayed in an exposed and distinguished presentation. Alternatively, user 140 comprising a wine vendor may prefer to attractively display a large quantity of wine bottle(s) 105 while conserving the most amount of space and therefore may be best served by either square alignment 400 or criss-cross alignment 500. Furthermore, in an alternative arrangement, two or more flexible wine rack assemblies 200 may be stackable one on top of the other and securably fastened via a fastening device providing flexible wine rack system 100 with a doubled height for storing a larger quantity of wine bottles 105 within the same amount of space.

Flexible wine rack systems 100 may be sold as kit 575 comprising the following parts: at least one flexible wine rack assembly 200 which may comprise at least one first vertically-orientated planar member 210, at least one second vertically-orientated planar member 215; at least two hinges 215; and at least one set of user instructions. In certain kits 575 the manufacturer may wish to sell with a collection of wine bottles 105 within kit 575. Flexible wine rack systems 100 may be manufactured and provided for sale in a wide variety of sizes, shapes, colors, and materials for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

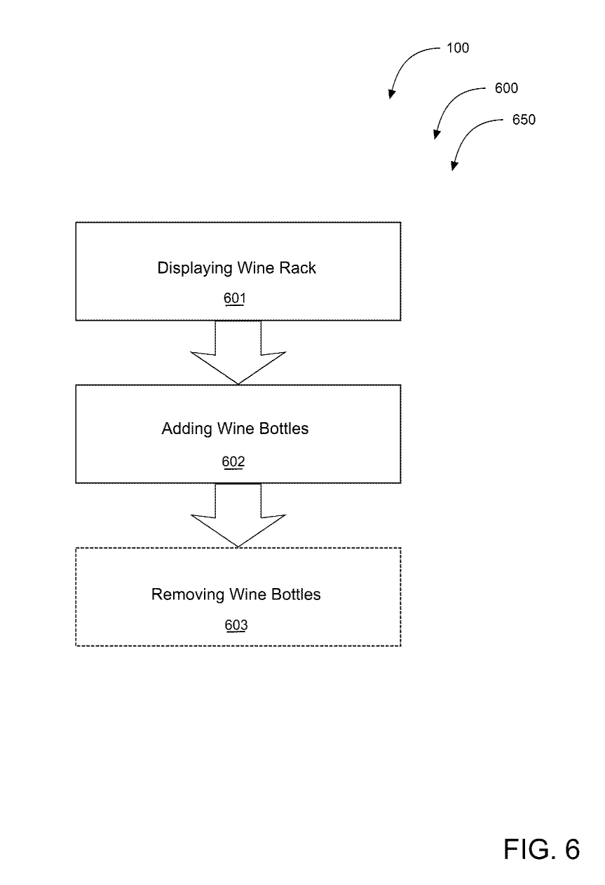

Referring now to FIG. 6, showing flowchart 650 illustrating method of use 600 for flexible wine rack systems 100. Method of use 600 may comprise the steps of: step one 601 displaying flexible wine rack assembly 200, step two 602 inserting wine bottle(s) 105 into through-holes 240 of flexible wine rack systems 100, and step three 603 removing wine bottle(s) 105 from through-holes 240 of flexible wine rack systems 100. It should be noted that step three 603 is an optional step and may not be implemented in all cases. Optional steps of method of use 600 are illustrated using dotted lines in FIG. 6 so as to distinguish them from the other steps of method of use 600 of flexible wine rack systems 100.

It should further be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A modular self-supporting wine rack comprising:
a first vertically-orientated planar member;
a second vertically-orientated planar member;
at least two hinges;
wherein said first vertically-orientated planar member and said second vertically-orientated planar member are securely held together in place at a perpendicular orientation by said at least two hinges;
wherein said first vertically-orientated planar member and said second vertically-orientated planar member maintain an upright vertical position in a self-supporting counterweight balanced manner maintaining said perpendicular orientation;
wherein said first vertically-orientated planar member and said second vertically-orientated planar member each comprise a plurality of cylindrical bottle-sized apertures comprising through-holes;
wherein wine bottles are insertably placable into said through-holes and securely held in place via frictional counter-balancing of said wine bottle(s) within said through-hole(s) in said vertically-orientated planar member(s); and
wherein said modular self-supporting wine rack serves to retain a plurality of said wine bottles in a spatially optimized and aesthetically pleasing usable-display.

2. The modular self-supporting wine rack of claim 1 wherein said first vertically-orientated planar member, said second vertically-orientated planar member, and said at least two hinges comprise a flexible wine rack assembly.

3. The modular self-supporting wine rack of claim 2 wherein said first vertically-orientated planar member and said second vertically-orientated planar member of said flexible wine rack assembly each comprise six of said cylindrical bottle-sized apertures comprising said through-holes.

4. The modular self-supporting wine rack of claim 3 wherein said through-holes of said first vertically-orientated planar member and said second vertically-orientated planar member comprise a diameter of 3 inches thereby providing a suitably-sized contact-retention inner circumference surface area for said wine bottle wherein said wine bottle contains a fluid volume of about 750 ml.

5. The modular self-supporting wine rack of claim 3, wherein said six through-holes are arranged into three rows and two columns said in each of said first vertically-orientated planar member and said second vertically-orientated planar member.

6. The modular self-supporting wine rack of claim 5, wherein said first vertically-orientated planar member and said second vertically-orientated planar member are attachable at a perpendicular orientation to one another by said at least two hinges such that said first vertically-orientated planar member and said second vertically-orientated planar member are in a 90 degree adjacent relation to each other and said three rows and said two columns are staggered in relation to each other in said first vertically-orientated planar member and said second vertically-orientated planar member thereby permitting vertically-staggered wine-storing space for said wine bottles.

7. The modular self-supporting wine rack of claim 1 wherein said at least two hinges comprise brass.

8. The modular self-supporting wine rack of claim 1, wherein said first vertically-orientated planar member and said second vertically-orientated planar member comprise a width of about 11½ inches and a height of about 48 inches.

9. The modular self-supporting wine rack of claim 8 wherein said first vertically-orientated planar member and said second vertically-orientated planar member are manufactured from oak.

10. The modular self-supporting wine rack of claim 9 wherein said first vertically-orientated planar member and said second vertically-orientated planar member each comprise rounded corners and a smooth-finished exterior surface.

11. The modular self-supporting wine rack of claim 1 wherein said first vertically-orientated planar member and said second vertically-orientated planar member comprise floor protectors serving to protect a floor from damage.

12. The modular self-supporting wine rack of claim 1 wherein said first vertically-orientated planar member and said second vertically-orientated planar member comprise composite material.

13. The modular self-supporting wine rack of claim 1 wherein said first vertically-orientated planar member and said second vertically-orientated planar member comprise different finish stains/colorings.

14. The modular self-supporting wine rack of claim 2 wherein at least two of said flexible wine rack assemblies are balance-displayable in at least one accordion alignment.

15. The modular self-supporting wine rack of claim 2 wherein at least two of said flexible wine rack assemblies are balance-displayable in at least one square alignment.

16. The modular self-supporting wine rack of claim 2 wherein at least two of said flexible wine rack assemblies are balance-displayable in at least one criss-cross alignment.

17. A modular-flexible self-supporting wine rack comprising:
a first vertically-orientated planar member comprising six circular apertures comprising 3 inch through-holes with a circumference surface area wherein said through-holes are arranged in three rows and two columns of said through-holes;
a second vertically-orientated planar member comprising six circular apertures comprising through-holes wherein said through-holes are arranged in three rows and two columns of said through-holes;
wherein said through-holes in said first vertically-orientated planar member and said through-holes in said second vertically-orientated planar member are staggered;
at least two hinging members comprising brass;
floor protectors serving to protect a floor from damage;
wherein said first vertically-orientated planar member and said second vertically-orientated planar member are securely held together in place at a perpendicular orientation by said at least two hinging members;
wherein said first vertically-orientated planar member and said second vertically-orientated planar member maintain an upright vertical position in a self-supporting counterweight balanced manner via said perpendicular orientation;
wherein said first vertically-orientated planar member and said second vertically-orientated planar member comprise a width of about 11½ inches and a height of about 48 inches;
wherein said first vertically-orientated planar member and said second vertically-orientated planar member are manufactured from red oak and each of said first vertically-orientated planar member and said second vertically-orientated planar member comprise rounded corners and a smooth-finished exterior surface;
wherein 750 ml wine bottles are insertably placable into touch-contact with said circumference surface area of said through-holes and securely held in place via frictional counter-balancing of said 750 ml wine bottle within said through-hole in said vertically-orientated planar member; and
wherein said modular self-supporting wine rack serves to retain a plurality of said 750 ml wine bottles with necks pointed outwardly in a spatially optimized and functional aesthetically pleasing balanced display.

18. The modular-flexible self-supporting wine rack of claim 17 further comprising a kit including at least one set of said first and second vertically-orientated planar members; said hinging members; fasteners; and a set of user instructions.

19. A method of using a modular self-supporting wine rack comprising the steps of:
installing a modular self-supporting wine rack in a user-preferred orientation;
balance-inserting wine bottles into through-holes to achieve at least one touch contact; and
removing said wine bottles from said through-holes.

20. The method of use of claim 19 further comprising the step of combining multiple said modular self-supporting wine racks together thereby creating an aesthetically pleasing display for balance-storing additional said wine bottles.
